(19) United States
(12) Patent Application Publication
(10) Pub. No.: US 2003/0129323 A1
(43) Pub. Date: Jul. 10, 2003

(54) Method for producing coatings, adhesive coatings and seals that can be cured using actinic radiation

(76) Inventors: Ludger Dornieden, Gronau (DE); Jorge Prieto, Senden (DE); Roland Steinrucken, Bruchhausen (DE); Reinhard Wiesing, Delbruck (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/220,978

(22) PCT Filed: Mar. 13, 2001
(86) PCT No.: PCT/EP01/02779

(30) Foreign Application Priority Data
Mar. 15, 2000 (DE) 100 12 580.8

(51) Int. Cl. B05D 3/06; C08J 3/28

(52) U.S. Cl. 427/553; 522/120; 522/182

(57) ABSTRACT

Process for producing coatings, adhesive films and/or seals from actinic-radiation-curable coating materials, adhesives and/or sealing compounds on and/or in primed and unprimed substrates by applying the coating materials, adhesives and/or sealing compounds onto and/or into the substrates and curing the resultant films with actinic radiation using photoinitiator-free coating materials, adhesives and sealing compounds comprising actinic-radiation-activatable constituents, A) at least one (meth)acrylate copolymer containing on average per molecule at least one group (a) having at least one actinic radiation activatable bond, group (a) being attached to the basic structure of the (meth)acrylate copolymer (A) by polymer-analogous reactions, or alternatively B) at least one compound containing on average per molecule at least one group (a) having at least one actinic radiation activatable bond, and C) at least one (meth)acrylate copolymer which is free of such groups (a), and which contain an amount of actinic-radiation-activatable groups of from 70 to 400 meq/100 g of solids.

The present invention relates to a novel process for producing coatings, adhesive films and/or seals on and/or in primed and unprimed substrates from actinic-radiation-curable coating materials, adhesives and/or sealing compounds.

By actinic radiation, here and below, is meant electromagnetic radiation such as near infrared, visible light, UV light or X-rays, but especially UV light, or corpuscular radiation such as electron beams.

Coating materials curable with actinic radiation are known. By way of example, refer to German patent DE 42 03 278 A1, which describes (meth)acrylate copolymers having pendant functional groups, such as epoxide groups or hydroxyl groups, for example, with molecular weights in the range from Mn 1000 to 10,000 with molecular weight distributions <4. These (meth)acrylate copolymers are subsequently reacted with acrylic acid or acrylic acid derivatives, such as acrylol chloride, to give the corresponding acrylated acrylates. These acrylated (meth)acrylate copolymers are used as binders in actinic-radiation-curable coating materials (cf. also European patent EP 0 650 979 A1). Also known are coating materials based on (meth)acrylate copolymers of low molecular weight (500-2500) and narrow distribution, which are obtained by anionic polymerization and are functionalized by polymer-analogous reaction with double bonds (cf. American patent U.S. Pat. No. 4,064,161 A1).

A key constituent of the known, actinic-radiation-curable coating materials are the photoinitiators, such as are described, for example, in Römpp Lexikon Lacke und Druckfarben, Georg Thieme Verlag, Stuttgart, New York, 1998, page 444 to 446: “photoinitiators”.

However, it is also possible to use (meth)acrylate copolymers free from olefinically unsaturated bonds in actinic-radiation-curable coating materials. These double-bond-free (meth)acrylate copolymers are crosslinked by way of H transfer to photochemically excited, copolymeric photoinitiators of Norrish type II (cf. German patent DE 44 13 436 A1). Similarly, double-bond-free (meth)acrylate copolymers containing copolymerized dihydrodicyclopentadienyl acrylate are crosslinked by way of H transfer to photochemically excited, copolymeric photoinitiators of Norrish type II (cf. German patent DE 196 00 147 A1).

Using these known coating materials it is possible in particular to coat heat-sensitive substrates.

A disadvantage, however, is that the use of photoinitiators—including photoinitiators attached to the binders—leads to emissions of decomposition products, some of them intense in odor, and/or to the yellowing of the coatings.

German patent DE 693 04 472 T2 discloses photoinitiator-free coating materials which serve to produce coatings on surfaces, cured using actinic radiation. For this purpose, a vinyl polymer containing acetoacetyl-functional groups is reacted with ammonia or primary amines to give enamines which are stable to hydrolysis in aqueous dispersion at a pH of 9. This produces more rapid curing of the coating materials following their application on the surfaces. The comparatively high level of ammonia or primary amines may give rise to an odor nuisance when the coating materials are handled and to yellowing of the cured coatings.

Coating materials curable thermally and with actinic radiation, also referred to as dual-cure coating materials, have advantages in the context of curing the coatings of three-dimensional substrates of complex shape, where radiation curing in the shadow regions is sometimes incomplete. The dual-cure coating materials are able on the one hand to compensate any incomplete thermal curing, carried out, for example, in order to protect heat-sensitive substrates, by WV curing or to compensate curing with UV light that is not entirely complete, in the shadow regions, for example, by thermal curing, so that in both cases the overall result is good.

Dual-cure coating materials and processes for producing coatings from them are known from European patent EP-A-0 928 800. The known coating material mandatorily includes a urethane (meth)acrylate containing (meth)acrylate groups and free isocyanate groups, a UV initiator (photoinitiator) that initiates free-radical polymerization, and an isocyanate-reactive compound. Compounds suitable as the isocyanate-reactive compound include polyols such as polyesters formed from diols and triols and also dicarboxylic acids, hindered amines formed from maleates and cycloaliphatic primary diamines, polyetherpolyols, or hydroxyl-containing (meth)acrylate copolymers.

Another dual-cure coating material is known from American patent U.S. Pat. No. 4,342,793 A1. It comprises a saturated polyol, especially a hydroxyl-functional (meth)acrylate copolymer, a reactive diluent for radiation curing, and a polyisocyanate. Crosslinking with actinic radiation is initiated by photoinitiators.

The known dual-cure coating materials therefore continue to have all of the disadvantages associated with the use of photoinitiators. Moreover, they are not unrestrictedly suitable for the coating of heat-sensitive substrates. A further disadvantage is that within the coating materials two different crosslinking mechanisms must be finely attuned to one another in order to obtain good results. Moreover, owing to their high reactivity, the polyisocyanates must be stored separately from the other constituents and cannot be added until shortly before use. After that, the coating materials must be applied within a short time, since they are not stable on storage.

A further feature common to all known actinic-radiation-curable coating materials and dual-cure coating materials is that they must be processed in the absence of daylight, in order to prevent premature crosslinking with actinic radiation. This, however, constitutes an additional logistical and equipment expense.

The problems depicted above also occur in the case of photoinitiator-containing adhesives and sealing compounds which are cured using actinic radiation.

It is an object of the present invention to provide a novel process for producing coatings, adhesive films and/or seals on and/or in primed and unprimed substrates from actinic-radiation-curable coating materials, adhesives and/or sealing compounds that no longer has the disadvantages of the prior art but which instead is carried out using coating materials, adhesives and/or sealing compounds which can be prepared and processed even in daylight, have a high storage stability, can be crosslinked below 50° C. even without the use of photoinitiators, and provide coatings, adhesive films and/or seals which are stable to weathering, are substantially free from yellowing, and are free from intensely odorous cleavage products.

A further object of the present invention was to provide novel coating materials, adhesives and sealing compounds which can be used with advantage in the abovementioned novel process.

Found accordingly has been the novel process for producing coatings, adhesive films and/or seals from actinic-radiation-curable coating materials, adhesives and/or sealing compounds on and/or in primed and unprimed substrates by applying the coating materials, adhesives and/or sealing compounds onto and/or into the substrates and curing the resultant films with actinic radiation, using photoinitiator-free coating materials, adhesives and sealing compounds comprising or consisting of, as actinic-radiation-activatable constituents,

A) at least one (meth)acrylate copolymer containing on average per molecule at least one group (a) having at least one bond which can be activated with actinic radiation, the group (a) being attached to the parent structure of the (meth)acrylate copolymer (A) by way of polymer-analogous reactions,

or alternatively

B) at least one compound containing on average per molecule at least one group (a) having at least one bond which can be activated with actinic radiation, and

C) at least one (meth)acrylate copolymer which is free of such groups (a),

and which contain an amount of actinic-radiation-activatable groups of from 70 to 400 meq/100 g of solids of (A) or (B)+(C).

The novel process is referred to below as “process of the invention”.

Also found have been the novel, photoinitiator-free coating materials, adhesives and sealing compounds containing an amount of actinic-radiation-activatable groups of from 70 to 400 meq/100 g of solids, which comprise or consist of, as actinic-radiation-activatable constituents,

A) at least one (meth)acrylate copolymer containing on average per molecule at least one group (a) having at least one bond which can be activated with actinic radiation, the group (a) being attached to the parent structure of the (meth)acrylate copolymer (A) by way of polymer-analogous reactions,

or alternatively

B) at least one compound containing on average per molecule at least one group (a) having at least one bond which can be activated with actinic radiation, and

C) at least one (meth)acrylate copolymer which is free of such groups (a).

Further subject matter of the invention will emerge from the description.

In the light of the prior art it was surprising and unforeseeable for the skilled worker that photoinitiator-free coating materials, adhesives and sealing compounds which consist of or comprise the constituent (A) or the specific combination of the constituents (B) and (C) can be cured with actinic radiation without using photoinitiators, with curing taking place at comparatively low temperatures below 50° C.

The process of the invention serves for producing coatings, adhesive films and seals, preferably coatings, especially single-coat and multicoat clearcoat systems and color and/or effect paint systems, on primed or unprimed substrates.

Suitable substrates include all surfaces to be coated, bonded and/or sealed which are undamaged by curing of the films and compositions present thereon and/or therein using actinic radiation; they include, for example, metals, plastics, wood, ceramic, stone, textile, fiber composites, leather, glass, glass fibers, glass wool and rock wool, mineral-bound and resin-bound building materials, such as plasterboard and cement slabs or roofing shingles, and composites of these materials.

Accordingly, the process of the invention is particularly suitable for the coating, bonding and/or sealing of motor vehicle bodies and parts of motor vehicle bodies, of furniture, constructions and industrial components, including coils, containers and electrical components. In the context of industrial application it is suitable for the coating, bonding and/or sealing of virtually all parts for private or industrial use such as radiators, household appliances, small metal parts such as nuts and bolts, hubcaps, wheel rims, packaging or electrical components such as motor windings or transformer windings.

In the case of electrically conductive substrates it is possible to use primers which are produced conventionally from electrocoat (EC) materials. Suitable for this purpose are both anodic and cathodic electrocoat materials, but especially cathodic. In the case of metal, the substrate may also have been subjected to a surface treatment, for example, galvanizing or phosphating or Eloxing.

Especially in automotive OEM finishing, a surfacer or antistonechip primer is applied to the fully cured or merely dried electrocoat. This coating film is cured fully either alone or together with the underlying electrocoat film. The applied surfacer film may also be merely dried or partly cured, before being cured fully with the above-lying paint films and also, where appropriate, with the underlying electrocoat film (extended wet-on-wet techniques). In the context of the present invention, the term “primer” also embraces the combination of electrocoat and surfacer coat or antistonechip primer.

The process of the invention can also be used to coat, bond and/or seal primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviated designations in accordance with DIN 7728T1). The plastics can of course also be polymer blends, modified plastics or fiber-reinforced plastics. It is possible to employ the plastics commonly used in vehicle construction, especially motor vehicle construction.

In the case of unfunctionalized and/or apolar substrate surfaces, these plastics may be subjected prior to coating, bonding or sealing in a known manner to a pretreatment, such as a plasma or by flaming, or may be provided with a hydroprimer.

The process of the invention serves preferably for producing coatings. The methods and apparatus employed in this case, described in more detail below, may also be employed for producing adhesive films and seals. Whether these methods and apparatus, known per se, are suitable for these end uses is something which the skilled worker is able to decide on the basis of his or her general art knowledge.

In a first advantageous variant of the process of the invention, in the first process step the actinic-radiation-curable coating material for inventive use, described below, is applied to the primed or unprimed substrate, resulting in a film of the coating material for inventive use. This process variant is employed in particular in the context of producing single-coat clearcoats.

In a second advantageous variant of the process of the invention, in the first process step the coating material for inventive use is applied to at least one basecoat film present on the substrate. The basecoat film may also comprise a pigmented dual-cure coating material. The basecoat film has preferably been merely dried or partly cured, so that it can be cured together with the film of the coating material for inventive use (wet-on-wet technique).

In a third advantageous variant of the process of the invention, the basecoat film is fully cured and is then overcoated with the coating material for inventive use.

The second and the third variant of the process of the invention is employed in particular for producing multicoat color and/or effect paint systems.

The application of the coating material for inventive use may take place by any of the customary application methods, such as spraying, knife coating, brushing, flow coating, dipping, impregnating, trickling or rolling, for example. The substrate to be coated may itself be at rest, with the application equipment or unit being moved. However, it is also possible for the substrate to be coated, in particular a coil, to be moved, with the application unit being at rest relative to the substrate or being moved appropriately.

Preference is given to the use of spray application methods, such as, for example, compressed-air spraying, airless spraying, high-speed rotation, electrostatic spray application (ESTA), alone or in conjunction with hot spray application such as hot-air spraying, for example. Application may take place at temperatures of max. 70 to 80° C., so that appropriate application viscosities are attained without any change or damage to the coating material for inventive use and its overspray (which may be intended for reprocessing) during the short period of thermal stress. Hot spraying, for instance, may be configured in such a way that the coating material for inventive use is heated only very briefly in the spray nozzle or shortly before the spray nozzle.

The spray booth used for application may be operated, for example, with a circulation system, which may be temperature-controllable, and which is operated with an appropriate absorption medium for the overspray, an example of such a medium being the coating material itself that is to be used in accordance with the invention.

Application of the coating material for inventive use can be carried out under visible light. In order to rule out entirely any material change or damage to the coating material for inventive use and the overspray, however, it is also possible to operate under illumination with visible light with a wavelength of more than 550 μm or in the absence of light, although this is not necessary in the great majority of cases.

In general, the coating materials for inventive use are applied in a wet film thickness such that curing thereof results in coatings having the thicknesses advantageous and necessary for their functions. In the case of a clearcoat these thicknesses are from 10 to 100 μm, preferably from 15 to 80 μm, with particular preference from 20 to 75 μm and in particular from 25 to 70 μm.

It is of course possible to employ the above-described application methods as well when producing the other coating films with a multicoat paint system as part of the process of the invention.

In the context of the process of the invention, the film of the coating material for inventive use is cured, following its application, using actinic radiation. In this case it is preferred to employ the actinic radiation curing methods described below.

In the context of the process of the invention, curing may take place immediately following the application of the film of the coating material for inventive use. Where appropriate, underlying coating films which have not yet been fully cured may be cured as well. In accordance with the invention it is of advantage if the primer and/or basecoat has or have already been fully cured.

Curing may take place after a certain rest time or flash-off time. This may have a duration of from 30 s to 2 h, preferably from 1 min to 1 h and in particular from 1 min to 45 min. The rest time serves, for example, for leveling and for devolatilization of the films and for the evaporation of volatile constituents such as any solvents still present.

In the case of curing with actinic radiation, it is preferred to employ a dose of from 2000 to 3000, more preferably from 2100 to 2950, with particular preference from 2200 to 2900, with very particular preference from 2300 to 2850, and in particular from 2400 to 2800 mJ/cm². If desired, this curing may be supplemented with actinic radiation from other radiation sources. In the case of electron beams, it is preferred to operate under an inert gas atmosphere. This may be ensured, for example, by supplying carbon dioxide and/or nitrogen directly to the surface of the clearcoat layer I. In the case of curing with WV radiation, as well, it is possible to operate under inert gas in order to prevent the formation of ozone. Curing with actinic radiation is carried out using the customary and known radiation sources and optical auxiliary measures. Examples of suitable radiation sources are flash lamps from the company VISIT, high or low pressure mercury vapor lamps, with or without lead doping in order to open up a radiation window up to 405 nm, or electron beam sources. Their arrangement is known in principle and may be adapted to the circumstances of the workpiece and the process parameters. In the case of workpieces of complex shape, as are envisaged for automobile bodies, the regions not accessible to direct radiation (shadow regions) such as cavities, folds and other structural undercuts may be (partly) cured using pointwise, small-area or all-round emitters, in conjunction with an automatic movement device for the exposure of cavities or edges.

The equipment and conditions for these curing methods are described, for example, in R. Holmes, U.V. and E.B. Curing Formulations for Printing Inks, Coatings and Paints, SITA Technology, Academic Press, London, United Kingdom 1984.

Curing here may take place in stages, i.e., by multiple exposure to light or actinic radiation. It may also take place alternatingly, i.e., by curing alternately with UV radiation and electron beams.

Of course, the curing methods described above may also be used for curing the other coating films in the context of the process of the invention in connection with the production of multicoat paint systems.

The single-coat or multicoat clearcoat system or color and/or effect paint system resulting from the process of the invention may further be coated with a coat of an organically modified ceramic material, such as is available commercially, for example, under the brand name Ormocer®.

As already mentioned above, the apparatus and methods described may also be employed, where suitable, for the production of adhesive films and seals by the process of the invention.

For the process of the invention it is essential that photoinitiator-free coating materials, adhesives and sealing compounds are used.

In accordance with the first alternative of the process of the invention, these photoinitiator-free coating materials, adhesives and sealing compounds comprise at least one (meth)acrylate copolymer (A) containing on average per molecule at least one, preferably at least two, and in particular at least three group(s) (a) having at least one, especially one, bond which can be activated with actinic radiation, or they consist thereof.

The (meth)acrylate copolymers used in accordance with the invention preferably contain essentially no monomers containing aceto groups, and with particular preference none at all.

In the context of the present invention, a bond which can be activated with actinic radiation means a bond which, on exposure to actinic radiation, becomes reactive and, with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as “double bonds”.

Especially suitable double bonds are present, for example, in (meth)acrylate, ethacrylate, crotonate, cinnamate, vinyl ether, vinyl ester, dicyclopentadienyl, norbornenyl, isoprenyl, isopropenyl, allyl or butenyl groups (a); dicyclopentadienyl ether, norbornenyl ether, isoprenyl ether, isopropenyl ether, allyl ether or butenyl ether groups (a); or dicyclopentadienyl ester, norbornenyl ester, isoprenyl ester, isopropenyl ester, allyl ester or butenyl ester groups (a). Of these, the acrylate groups (a) offer very particular advantages, and so are used with very particular preference in accordance with the invention.

The groups (a) in the (meth)acrylate copolymers (A) are preferably attached to the respective parent structures by way of urethane, urea, allophanate, ester, ether and/or amide groups, but in particular by way of ester groups. This normally takes place by means of customary and known, polymer-analogous reactions such as, for instance, the reaction of pendant glycidyl groups with the olefinically unsaturated monomers (a4) described below and containing an acid group, or of pendant hydroxyl groups with the halides of these monomers (a4).

Examples of suitable monomers (a) for preparing the parent structure of the (meth)acrylate copolymers (A) are

Monomers (a1):

(Meth)acrylic acid alkyl or cycloalkyl esters which contain essentially no functional groups, having up to 20 carbon atoms in the alkyl radical, especially methyl, ethyl, propyl, n-butyl, sec-butyl, tert-butyl, hexyl, ethylhexyl, stearyl and lauryl acrylate or methacrylate; cycloaliphatic (meth)acrylic esters, especially cyclohexyl, isobornyl, dicyclopentadienyl, octahydro-4,7-methano-1H-indenemethanol or tert-butyl-cyclohexyl (meth)acrylate; (meth)acrylic acid oxaalkyl esters or oxacycloalkyl esters such as ethyl triglycol (meth)acrylate and methoxyoligoglycol (meth)acrylate having a molecular weight Mn of preferably 550; or other ethoxylated and/or propoxylated, hydroxyl-free (meth)acrylic acid derivatives. These may include minor amounts of (meth)acrylic acid alkyl or cycloalkyl esters of higher functionality, such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate. In the context of the present invention, minor amounts of monomers (a1) of higher functionality here are amounts which do not lead to crosslinking or gelling of the polyacrylate resins.

Monomers (a2):

Vinyl esters of alpha-branched monocarboxylic acids having from 5 to 18 carbon atoms in the molecule and containing essentially no functional groups. The branched monocarboxylic acids can be obtained by reacting formic acid or carbon monoxide and water with olefins in the presence of a liquid, strongly acidic catalyst; the olefins may be cracking products of paraffinic hydrocarbons, such as mineral oil fractions, and may include both branched and straight-chain acyclic and/or cycloaliphatic olefins. The reaction of such olefins with formic acid or, respectively, with carbon monoxide and water produces a mixture of carboxylic acids in which the carboxyl groups are located predominantly on a quaternary carbon atom. Examples of other olefinic starting materials are propylene trimer, propylene tetramer and diisobutylene. Alternatively, the vinyl esters may be prepared in conventional manner from the acids, by reacting, for example, the acid with acetylene. Particular preference, owing to their ready availability, is given to using vinyl esters of saturated aliphatic monocarboxylic acids having from 9 to 11 carbon atoms that are branched on the alpha carbon atom.

Monomers (a3):

Olefinically unsaturated monomers containing essentially no functional groups, such as

olefins such as ethylene, propylene, but-1-ene, pent-1-ene, hex-1-ene, cyclohexene, cyclopentene, norbornene, butadiene, isoprene, cyclopentadiene and/or dicyclopentadiene;

vinylaromatic hydrocarbons, such as styrene, alpha-alkylstyrenes, especially alpha-methylstyrene, arylstyrenes, especially diphenylethylene, and/or vinyltoluene;

nitrites such as acrylonitrile and/or methacrylonitrile;

vinyl compounds such as vinyl chloride, vinyl fluoride, vinylidene dichloride, vinylidene difluoride; N-vinylpyrrolidone; vinyl ethers such as ethyl vinyl ether, n-propyl vinyl ether, isopropyl vinyl ether, n-butyl vinyl ether, isobutyl vinyl ether and/or vinyl cyclohexyl ether; vinyl esters such as vinyl acetate, vinyl propionate, vinyl butyrate, vinyl pivalate, vinyl esters of Versatic® acids, sold under the brand name VeoVa® by the company Deutsche Shell Chemie (for further details, refer to Römpp Lexikon Lacke und Druckfarben, Georg Thieme Verlag, Stuttgart, New York, 1998, page 598 and also pages 605 and 606) and/or the vinyl ester of 2-methyl-2-ethylheptanoic acid; and/or

polysiloxane macromonomers having a number-average molecular weight Mn of from 1000 to 40,000, preferably from 2000 to 20,000, with particular preference from 2500 to 10,000, and in particular from 3000 to 7000 and containing on average from 0.5 to 2.5, preferably from 0.5 to 1.5, ethylenically unsaturated double bonds per molecule, as described in DE 38 07 571 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1 or in the international patent application WO 92/22615 on page 12, line 18, to page 18, line 10, or acryloyloxysilane-containing vinyl monomers, preparable by reacting hydroxy-functional silanes with epichlorohydrin and subsequently reacting the reaction product with methacrylic acid and/or hydroxyalkyl esters of (meth)acrylic acid.

The above-described monomers (a) are selected such that the resulting parent structures of the (meth)acrylate copolymers (A) are substantially determined, in their profile of properties, by the monomers (a1).

The parent structures of the (meth)acrylate copolymers (A) further contain functional groups which—as already mentioned above—serve to introduce groups (a). In addition, these functional groups may also be used to vary the profile of properties of the (meth)acrylate copolymers (A) for inventive use.

The functional groups are appropriately introduced into the parent structures of the (meth)acrylate copolymers (A) by the copolymerization of monomers (a) containing corresponding functional groups. Examples of suitable monomers (a) of this kind are:

Monomers (a4):

Ethylenically unsaturated monomers carrying at least one acid group, preferably a carboxyl group, per molecule, with particular preference acrylic acid and/or methacrylic acid. It is, however, also possible to use other ethylenically unsaturated carboxylic acids having up to 6 carbon atoms in the molecule. Examples of such acids are ethacrylic acid, crotonic acid, maleic acid, fumaric acid and itaconic acid. Further, it is possible to use ethylenically unsaturated sulfonic or phosphonic acids, and/or their partial esters. Also suitable, furthermore, are mono(meth)acryloyloxyethyl maleate, mono(meth)acryloyloxyethyl succinate and mono(meth)acryloyloxyethyl phthalate.

Hydroxyl-containing monomers such as hydroxyalkyl esters of acrylic acid, methacrylic acid or another alpha,beta-ethylenically unsaturated carboxylic acid which derive from an alkylene glycol which is esterified with the acid, or are obtainable by reacting the acid with an alkylene oxide, especially hydroxyalkyl esters of acrylic acid, methacrylic or ethacrylic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate or crotbnate; 1,4-bis(hydroxymethyl)cyclohexane, octahydro-4,7-methano-1H-indenedimethanol or methylpropanediol monoacrylate, monomethacrylate, monoethacrylate or monocrotonate; or reaction products of cyclic esters, such as epsilon-caprolactone, for example, and these hydroxyalkyl esters; or olefinically unsaturated alcohols such as allyl alcohol or polyols such as trimethylolpropane monoallyl or diallyl ether or pentaerythritol monoallyl, diallyl or triallyl ether. These monomers of higher functionality are generally used only in minor amounts. In the context of the present invention, minor amounts of monomers of higher functionality here are amounts which do not lead to crosslinking or gelling of the polyacrylate resins.

Monomers containing epoxide groups, such as the glycidyl ester of acrylic acid, methacrylic acid, ethacrylic acid, crotonic acid, maleic acid, fumaric acid and/or itaconic acid.

(Meth)acrylamides such as (meth)acrylamide, N-methyl-, N,N-dimethyl-, N-ethyl-, N,N-diethyl-, N-propyl-, N,N-dipropyl, N-butyl-, N,N-dibutyl-, N-cyclohexyl- and/or N,N-cyclohexyl-methyl-(meth)acrylamide.

Reaction product of acrylic acid and/or methacrylic acid with the glycidyl ester of an alpha-branched monocarboxylic acid having from 5 to 18 carbon atoms per molecule. The reaction of the acrylic or methacrylic acid with the glycidyl ester of a carboxylic acid having a tertiary alpha carbon atom may take place before, during or after the polymerization reaction. The reaction product of acrylic and/or methacrylic acid with the glycidyl ester of Versatic® acid is employed with preference. This glycidyl ester is available commercially under the name Cardura® E10. For further details, refer to Römpp Lexikon Lacke und Druckfarben, Georg Thieme Verlag, Stuttgart, New York, 1998, pages 605 and 606.

Where used, glycidyl-containing monomers (a) are employed in particular.

Viewed in terms of method, the preparation of the parent structures of the (meth)acrylate copolymers (A) has no special features but instead takes place in accordance with the customary and known methods of free-radical polymerization in the presence of at least one polymerization initiator, in bulk, in solution or in emulsion.

Examples of suitable polymerization initiators are initiators which form free radicals, such as dialkyl peroxides such as di-tert-butyl peroxide or dicumyl peroxide; hydroperoxides such as cumene hydroperoxide or tert-butyl hydroperoxide; peresters, such as tert-butyl perbenzoate, tert-butyl perpivalate, tert-butyl per-3,5,5-trimethylhexanoate or tert-butyl per-2-ethyl-hexanoate; azo dinitriles such as azbbisisobutyronitrile; C—C cleaving initiators such as benzpinacol silyl ethers. The initiators are used preferably in an amount of from 0.1 to 25% by weight, with particular preference from 0.75 to 10% by weight, based on the overall weight of the monomers (a). In order to regulate the molecular weight, it is also possible to use at least one customary and known molecular weight regulator such as dodecyl mercaptan.

The polymerization is appropriately conducted at a temperature of from 50 to 200° C., preferably from 70 to 180° C., where appropriate under pressure.

Where employed, it is preferred as solvents to use the organic solvents (D) described below, especially mixtures of aromatic hydrocarbons or alcohols, esters, ethers, ether alcohols, ester ethers and/or ketones, or the reactive diluents (D) for thermal crosslinking that are described below. The solvents may serve as additive (D) in the coating materials, adhesives and sealing compounds for inventive use.

In terms of apparatus as well, the preparation of the parent structures of the (meth)acrylate copolymers (A) has no special features in terms of method but instead takes place by means of the methods of continuous or batchwise copolymerization that are customary and known in the polymers field, under atmospheric pressure or superatmospheric pressure, in stirred tanks, autoclaves, tube reactors, loop reactors or Taylor reactors.

Examples of suitable copolymerization processes are described in the patents DE 197 09 465 A1, DE 197 09 476 C1, DE 28 48 906 A1, DE 195 24 182 A1, EP 0 554 783 A1, DE 198 28 742 A1, WO 95/27742 or WO 82/02387.

The introduction of the groups (a) into the parent structures of the (meth)acrylate copolymers (A) also has no special features in terms of method or apparatus but instead takes place in customary and known reactors such as stirred tanks, autoclaves, tube reactors, loop reactors or Taylor reactors or in extruders, as described for example in European patent application EP 0 650 979 A1.

Suitable (meth)acrylate copolymers (A) are available commercially and are sold, for example, by the company Jäger under the brand name Jägalux® (for example, Jägalux® 6154).

The amount of the (meth)acrylate copolymers (A) in the coating materials, adhesives and sealing compounds for inventive use may vary very widely and is guided by the requirements of the case in hand. The amount, always with compliance with the limits according to the invention for the groups which can be activated with actinic radiation, may be for example virtually 100% by weight or exactly 100% by weight. The (meth)acrylate copolymers (A) are preferably used in an amount of from 5 to 80%, more preferably from 10 to 75%, with particular preference from 15 to 70%, with very particular preference from 20 to 65% and in particular from 25 to 60% by weight, based on the coating material, the adhesive or the sealing compound. Moreover, the coating materials, adhesives and sealing compounds for inventive use may further comprise the below-described compounds (B), (meth)acrylate copolymers (C) and additives (D) in minor amounts. In the context of the invention, “minor amounts” here denote amounts which advantageously vary but do not fundamentally determine the profile of properties of the coating materials, adhesives and sealing compounds for inventive use.

In a second alternative of the process of the invention, photoinitiator-free coating materials, adhesives and sealing compounds are used which comprise or consist of

B) at least one compound containing on average per molecule at least one, preferably at least two, and in particular at least three groups (a) having at least one, especially one, bond which can be activated with actinic radiation, and

C) at least one (meth)acrylate copolymer which is free from such groups (a).

Examples of suitable groups (a) are those described above.

Preferably, the groups (a) are attached to the parent structures in the compounds (B) by way of urethane, urea, allophanate, ester, ether and/or amide groups. Urethane groups are particularly preferred here. The following two linking structures I and II come into consideration for this purpose:

parent structure-NH—C(O)—O-group (a) (I) and

parent structure-O—(O)C—NH-group (a) (II).

The compound (B) may contain both linking structures I and II or only one of them. In general, the structure I is of advantage, owing to the larger number of starting materials available and their comparatively greater ease of preparation, and is therefore employed with preference in accordance with the invention.

The groups (a) are attached terminally and/or laterally to the parent structures of the compounds (B). Which type of attachment is chosen depends in particular on whether the functional groups are present terminally or laterally in the parent structure with which the starting products of the groups (a) are able to react. In many cases, terminal groups (a) are more reactive than lateral groups (a), owing to the absence of steric shielding, and are therefore used with preference. On the other hand, however, the reactivity of the solid of the invention may be specifically controlled by way of the ratio of terminal to lateral groups (a), which is a further particular advantage of the solid of the invention.

The parent structures of the compounds (B) are of low molecular mass, oligomeric and/or polymeric. That is to say that the parent structures are low molecular mass compounds, oligomers or polymers. Or else the compounds (B) have low molecular mass and oligomeric, low molecular mass and polymeric, oligomeric and polymeric, or low molecular mass, oligomeric, and polymeric parent structures; in other words, they are mixtures of low molecular mass compounds and oligomers, of low molecular mass compounds and polymers, of oligomers and polymers, or of low molecular mass compounds, oligomers, and polymers.

In the context of the present invention, oligomers are resins whose molecule contains at least 2 to 15 monomer units. In the context of the present invention, polymers are resins whose molecule contains at least 10 repeating monomer units. For further details of these terms, refer to Römpp, op. cit., “oligomers”, page 425.

The low molecular mass, oligomeric or polymeric parent structures comprise or consist of aromatic, cycloaliphatic and/or aliphatic structures or building blocks. They preferably comprise or consist of cycloaliphatic and/or aliphatic structures, especially cycloaliphatic and aliphatic structures.

Examples of suitable aromatic structures are aromatic and heteroaromatic rings, especially benzene rings.

Examples of cycloaliphatic structures are cyclobutane, cyclopentane, cyclohexane, cycloheptane, norbornane, camphane, cyclooctane or tricyclodecane rings, especially cyclohexane rings.

Examples of aliphatic structures are linear or branched alkyl chains having from 2 to 20 carbon atoms, or chains as result from the addition (co)polymerization of olefinically unsaturated monomers.

The parent structures, especially the oligomeric and/or polymeric parent structures, may further comprise olefinically unsaturated double bonds.

The parent structures, especially the oligomeric and/or polymeric parent structures, are of linear, branched, hyperbranched or dendrimeric structure.

They may comprise polyvalent, especially divalent, functional groups (b) by means of which the above-described structures or building blocks are linked with one another to the parent structures. These are generally selected in such a way that they do not disrupt, let alone completely prevent, the reactions initiated by the actinic radiation. Examples of suitable functional groups are ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, urethane, hydrazide, urea, thiourea, carbonyl, thiocarbonyl, sulfone, sulfoxide or siloxane groups. Of these groups, the ether, carboxylate, carbonate, carboxamide, urea, urethane, imide and carbonate groups, especially the carboxylate and the urethane groups, are of advantage and are therefore used with preference.

Advantageous oligomeric and polymeric parent structures are therefore derived from random, alternating and/or block, linear, branched, hyperbranched, dendrimeric and/or comb addition (co)polymers (B) of ethylenically unsaturated monomers, polyaddition resins and/or polycondensation resins (B). For further details of these terms, refer to Römpp, op. cit., page 457: “polyaddition” and “polyaddition resins (polyadducts)”, and also pages 463 and 464: “polycondensates”, “polycondensation”, and “polycondensation resins”.

Examples of highly suitable addition (co)polymers (B) are (meth)acrylate copolymers and partially saponified polyvinyl esters. The above-described (meth)acrylate copolymers (A) are especially suitable.

Examples of highly suitable polyaddition resins and/or polycondensation resins (B) are polyesters, alkyds, polyurethanes, polyester-polyurethanes, polylactones, polycarbonates, polyethers, polyester-polyethers, epoxy resin-amine adducts, polyureas, polyamides or polyimides. Of these, the polyesters, polyester-polyethers, polyurethanes and polyester-polyurethanes are particularly advantageous and are therefore used with very particular preference in accordance with the invention.

The polyaddition resins and/or polycondensation resins (B) are customary and known, commercially available products which are sold, for example, by the company Bayer under the brand name Roskydal® (for example, Roskydal® UA LP V94/504-5), by the company Cray Valley under the brand name Sartomer® (for example, Sartomer® 494 or 9003) or by the company BASF Aktiengesellschaft under the brand name Laromer® (for example, Laromer® PO 84F or PO 83F).

Examples of suitable low molecular mass compounds (B) are the reactive diluents, as described, for example, in Römpp Lexikon Lacke und Druckfarben, Georg Thieme Verlag, Stuttgart, New York, 1998, page 491: “reactive diluents”.

The amount of the compounds (B) in the coating materials, adhesives and sealing compounds for inventive use may vary very widely, guided by the requirements of the case in hand. They preferably contain the compounds (B) in an amount, based in each case on the solids content of the coating material, adhesive or sealing compound, of from 2.0 to 45%, more preferably from 3.0 to 40%, with particular preference from 4.0 to 35%, with very particular preference from 5.0 to 30% and in particular from 6.0 to 5% by weight.

Furthermore, the coating materials, adhesives and sealing compounds for use in this alternative of the process of the invention comprise at least one (meth)acrylate copolymer (C) which is free from actinic-radiation-activatable groups (a). The (meth)acrylate copolymers (C) may contain functional groups. These, however, serve only for varying the physicochemical profile of properties of the (meth)acrylate copolymers (C) and are not essential for the crosslinking with actinic radiation.

Examples of suitable (meth)acrylate copolymers (C) are the above-described parent structures of the (meth)acrylate copolymers (A). These comprise customary and known products which are available commercially and are sold, for example, by the company Bayer AG under the brand name Desmophen® A 450, 365, 565, VP LS 2180, VP LS 2177 or LS 2009/1, by the company DSM under the brand name Uracron® (for example, Uracron® CY 467 E, 476 CY, CY 403 E, CY 455 XK1 or 458 XE), by the company Synthopol under the brand name Synthalat® (for example, Synthalat® A 1613 or 1633).

The amount of the (meth)acrylate copolymers (C) in the coating materials, adhesives and sealing compounds for inventive use may also vary very widely and is guided by the requirements of the case in hand. In the coating materials the (meth)acrylate copolymers (C) are present preferably in an amount of from 65 to 98%, more preferably from 60 to 97%, with particular preference from 65 to 96%, with very particular preference from 70 to 95% and in particular from 75 to 94% by weight, based in each case on the coating material, adhesive or sealing compound.

Irrespective of which alternative of the process of the invention is employed and irrespective of what the specific composition of the coating materials, adhesives and sealing compounds for inventive use is in that case, they inventively have a group (a) content of from 70 to 400, preferably from 75 to 395, more preferably from 80 to 390, with particular preference from 85 to 385 and in particular from 90 to 380 meq/100 g of solids of (A) or (B)+(C).

The coating materials, adhesives, and sealing compounds for use in accordance with the invention comprise at least one additive (D) selected from the group consisting of color and/or effect pigments, organic and inorganic, transparent or opaque fillers, nano-particles, further oligomeric and polymeric binders other than (A), (B) and (C), reactive diluents curable thermally, low-boiling organic solvents and high-boiling (“long”) organic solvents, water, UV absorbers, light stabilizers, free-radical scavengers, devolatilizers, slip additives, polymerization inhibitors, defoamers, emulsifiers, wetting agents, dispersants, adhesion promoters, leveling agents, film-forming auxiliaries, sag control agents (SCAs), rheology control additives (thickeners), flame retardants, siccatives, driers, antiskinning agents, corrosion inhibitors, waxes, and flatting agents;

The nature and amount of the additives (D) are guided by the intended use of the coatings, adhesive films, and seals produced with the aid of the process of the invention.

Where the coating material for inventive use is used to produce solid-color topcoats or basecoats, it comprises color and/or effect pigments (D) and also, if desired, opaque fillers. Where the coating material for inventive use is used to produce clearcoats, these additives (D) are of course not present in it.

Examples of suitable effect pigments (D) are metal flake pigments such as commercially customary aluminum bronzes, aluminum bronzes chromated in accordance with DE 36 36 183 A1, and commercially customary stainless steel bronzes, and also nonmetallic effect pigments, such as pearlescent pigment and interference pigment, for example. For further details, refer to Römpp, op. cit., page 176, “effect pigments” and pages 380 and 381, “metal oxide-mica pigments” to “metal pigments”.

Examples of suitable inorganic color pigments (D) are titanium dioxide, iron oxides, Sicotrans yellow, and carbon black. Examples of suitable organic color pigments (D) are thioindigo pigments, indanthrene blue, Cromophthal red, Irgazine orange, and Heliogen green. For further details, refer to Römpp, op. cit., pages 180 and 181, “iron blue pigments” to “black iron oxide”, pages 451 to 453, “pigments” to “pigment volume concentration”, page 563, “thioindigo pigments”, and page 567, “titanium dioxide pigments”.

Examples of suitable organic and inorganic fillers (D) are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers, or wood flour. For further details, refer to Römpp, op. cit., pages 250 ff, “fillers”.

These pigments and fillers (D) may also be incorporated into the coating materials by way of pigment pastes, in which case suitable grinding resins include the above-described (meth)acrylate copolymers (C) which carry functional groups.

Examples of suitable binders (D) are other thermally and/or actinic-radiation-curable linear and/or branched and/or block, comb and/or random polyesters, alkyds, polyurethanes, acrylated polyurethanes, acrylated polyesters, polylactones, polycarbonates, polyethers, epoxy resin-amine adducts, partially saponified polyvinyl esters or polyureas or actinic-radiation-curable unsaturated polyesters, epoxy acrylates, urethane acrylates, amino acrylates, melamine acrylates, silicone acrylates, and the corresponding methacrylates, which are employed in minor amounts. In the context of the invention, “minor amounts” here denote amounts which advantageously vary but do not fundamentally determine the profile of properties of the coating materials, adhesives and sealing compounds for inventive use.

Examples of suitable thermally curable reactive diluents (D) are positionally isomeric diethyl-octanediols or hydroxyl-containing hyperbranched compounds or dendrimers.

Examples of suitable low-boiling organic solvents (D) and high-boiling organic solvents (D) (“long solvents”) are ketones such as methyl ethyl ketone or methyl isobutyl ketone, esters such as ethyl acetate or butyl acetate, ethers such as dibutyl ether or ethylene glycol, diethylene glycol, propylene glycol, dipropylene glycol, butylene glycol or dibutylene glycol dimethyl, diethyl or dibutyl ethers, ether alcohols such as ethylene glycol monomethyl ether, ethylene glycol monoethyl ether or methoxypropanol, ester ethers such as 3-methoxybutyl acetate, N-methylpyrrolidone or xylenes, or mixtures of aromatic hydrocarbons such as Solvent Naphtha® or Solvesso®.

Examples of suitable light stabilizers (D) are HALS compounds, benzotriazoles or oxalanilides.

An example of a suitable devolatilizer (D) is diazadicycloundecane;

examples of suitable emulsifiers (D) are nonionic emulsifiers, such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols.

Examples of suitable wetting agents (D) are siloxanes, fluorine compounds, carboxylic monoesters, phosphates, polyacrylic acids and their copolymers, or polyurethanes.

An example of a suitable adhesion promoter (D) is tricyclodecanedimethanol.

Examples of suitable film-forming auxiliaries (D) are cellulose derivatives such as cellulose acetobutyrate (CAB).

Examples of suitable transparent fillers (D) are those based on silica, alumina or zirconium oxide; for further details, refer to Römpp, op. cit., pages 250 to 252.

Examples of suitable sag control agents (D) are ureas, modified ureas and/or silicas, as described for example in the references EP 0 192 304 A1, DE 23 59 923 A1, DE 18 05 693 A1, WO 94/22968, DE 27 51 761 C1, WO 97/12945 or “farbe+lack”, 11/1992, pages 829 ff.

Examples of suitable rheology control additives (D) are those known from the patents WO 94/22968, EP 0 276 501 A1, EP 0 249 201 A1 or WO 97/12945; crosslinked polymeric microparticles, as disclosed for example in EP 0 008 127 A1; inorganic phyllosilicates such as aluminum magnesium silicates, sodium magnesium and sodium magnesium fluorine lithium phyllosilicates of the montmorillonite type; silicas such as Aerosils; or synthetic polymers containing ionic and/or associative groups, such as polyvinyl alcohol, poly(meth)acryl-amide, poly(meth)acrylic acid, polyvinylpyrrolidone, styrene-maleic anhydride or ethylene-maleic anhydride copolymers and their derivatives or hydrophobically modified ethoxylated urethanes or polyacrylates.

An example of a suitable flatting agent (D) is magnesium stearate.

Further examples of the above-recited additives (D) and also examples of suitable UV absorbers, free-radical scavengers, leveling agents, flame retardants, siccatives, driers, antiskinning agents, corrosion inhibitors and waxes (D) are described in detail in the textbook “Lackadditive” [Additives for coatings] by Johan Bieleman, Wiley-VCH, Weinheim, New York, 1998.

Moreover, water can be used as an additive (D), especially if coating materials are to be prepared.

The additives (D) are used in customary and known, effective amounts.

The preparation of the coating materials, adhesives, and sealing compounds for inventive use has no special features but instead takes place in a customary and known manner by mixing of the above-described constituents in suitable mixing equipment such as stirred tanks, dissolvers, stirred mills or extruders in accordance with the techniques which are suitable for the preparation of the respective coating materials, adhesives and sealing compounds for inventive use.

The coating materials, adhesives and sealing compounds for use in accordance with the invention may be present in the form of virtually or completely water-free and solvent-free liquids (100% systems) or powders, of powders dispersed in aqueous media (powder slurries), of aqueous dispersions or solutions, or of dispersions or solutions in organic solvents (conventional systems).

The coatings produced by means of the process of the invention, especially the single-coat and multicoat clearcoat systems and color and/or effect paint systems, are of the very highest optical quality as regards color, effect, gloss, and D.O.I (distinctiveness of the reflected image), have a smooth, structureless, hard, flexible, and scratch-resistant surface, are free of odor and resistant to weathering, chemicals and etching, do not yellow, and display no cracking or delamination of the coats.

The adhesive films produced by means of the process of the invention have an extremely high bond strength, even under extreme climatic conditions, which does not decrease even after long years of exposure to light and the atmosphere.

The seals produced by means of the process of the invention seal the substrates completely, even in the presence of aggressive media.

The primed or unprimed substrates which have been coated, bonded and/or sealed with the aid of the process of the invention therefore have a particularly long service life and a particularly high utility, making them especially attractive both technically and economically to manufacturers, applicators and end users.

### EXAMPLES AND COMPARATIVE EXPERIMENTS

### Examples 1 to 4 and Comparative Experiment C1

The production of clearcoats inventively (examples 1 to 4) and noninventively (comparative experiment C1)

For examples 1 to 4 and comparative experiment C1, a mixture (A) was used comprising, based on the mixture, 50% of a methacrylate copolymer of methyl methacrylate and ethyl acrylate which had been modified with glycidyl methacrylate and acrylic acid, 47% by weight of hexane-1,6-diol diacrylate (B) and 3.0% by weight of xylene (D).

As solvents (D) the customarily used mixtures (D) of esters, ketones, ether alcohols and aromatic solvents were used.

The clearcoat materials were prepared conventionally by mixing the constituents in a suitable mixing unit.

Here, in the case of example 1, 56.4 parts by weight of solvent (D), 9.1 parts by weight of the mixture (A), 27.7 parts by weight of a commercial (meth)acrylate copolymer (C) (Uracron® CY 467 from DSM, 55% in butyl acetate), 4.5 parts by weight of cellulose acetobutyrate, 1.8 parts by weight of a commercial flatting agent and 0.5 part by weight of a commercial defoamer were mixed with one another.

For comparative experiment C1, example 1 was repeated but with the further addition of 5.0 parts by weight of a commercial photoinitiator.

For example 2, 36.4 parts by weight of the (meth)acrylate copolymer (C) used in example 1, 9.0 parts by weight of the mixture (A) and 54.6 parts by weight of solvent (D) were mixed with one another.

For example 3, 47.7 parts by weight of a methacrylate copolymer (C) made from methyl methacrylate, acrylic acid and acrylonitrile with an acid number of from 40 to 50 mg KOH/g, 9.0 parts by weight of the mixture (A) and 43.3 parts by weight of solvent (D) were mixed with one another.

For example 4, 47.7 parts by weight of a methacrylate copolymer (C) made from butyl methacrylate and methyl methacrylate, 9.0 parts by weight of the mixture (A) and 43.3 parts by weight of solvent (D) were mixed with one another.

The clearcoat materials described above were applied to glass plates using a 200 μm box-type doctor blade.

After an evaporation time of 10 minutes, they were physically predried in a forced air dryer at 50° C. for 30 minutes. Subsequent UV exposure was carried out using 2 CK lamps (80 W/cm) with a rate of advance of 5.5 m/min. After a cooling time of 10 minutes, the König pendulum attenuation of the clearcoats (cf. Römpp Lexikon und Druckfarben, Georg Thieme Verlag, Stuttgart, New York, 1998, page 436: “pendulum attenuation testing”) was determined as a measure of their degree of crosslinking. For comparison, the pendulum attenuation of the dried clearcoat films prior to exposure was measured. The results are given in Table 1.

TABLE 1
König pendulum attenuation testing

| | |
|---|---|
| | Pendulum |
| Example and | attenuation(s) |

| comparative experiment | before exposure | after exposure |
|---|---|---|
| 1 | 25.6 | 104.4 |
| C1 | 25.2 | 101.2 |
| 2 | 21.7 | 162.4 |
| 3 | 25.2 | 176.4 |
| 4 | 27.3 | 151.2 |

The results in the table demonstrate that there was no need for any photoinitiators for crosslinking in the clearcoat materials for inventive use. Moreover, the results demonstrate the surprising finding that crosslinking did not necessitate functionalization of the (meth)acrylate copolymers (A) or (C).

### Example 5 and Comparative Experiment C2

The Production of Clearcoats Inventively (Example 5) and Noninventively (Comparative Experiment C2)

For example 5 and comparative experiment C2, a clearcoat material comprising 61.1 parts by weight of a solvent mixture [mixture (D) from example 1 to 4] and 38.9 parts by weight of a commercial (meth)acrylate copolymer (A) (Jägalux® UV 6154 from Jäger) was used. For comparative experiment C2, this mixture was admixed further with 0.5 part by weight of a mixture of the commercial photoinitiators Grenocure MBF and Irgacure 184 (weight ratio 6:1).

The clearcoats were produced as described for examples 1 to 4 and comparative experiment C1.

In the case of example 5, König pendulum attenuation testing prior to exposure to UV light gave a value of 92.4 s and after exposure a value of 165.2 s. The corresponding values for comparative experiment C2 were 92.4 s and 168.7 s. Therefore, crosslinking of the clearcoat was completed even without photoinitiators.

### Examples 6 to 17 and Comparative Experiment C3 to C14

The production of Clearcoats Inventively (Examples 6 to 17) and Noninventively (Comparative Experiment C3 to C14)

For examples 6 to 17, the clearcoat materials indicated in Table 2 were used. For comparative experiments C3 to C14, they were further admixed with 0.5 parts by weight of a mixture of the commercial photoinitiators Grenocure MBF and Irgacure 184 (weight ratio 6:1). Examples 6 to 17 and comparative experiments C3 to C14 correspond as follows:

| Example | Comparative experiment |
|---|---|
| 6 | C3 |
| 7 | C4 |
| 8 | C5 |
| 9 | C6 |
| 10 | C7 |
| 11 | C8 |
| 12 | C9 |
| 13 | C10 |
| 14 | C11 |
| 15 | C12 |
| 16 | C13 |
| 17 | C14 |

The clearcoats were produced as indicated in the above-described examples and comparative experiments.

The double bond content and the results of König pendulum attenuation testing before and after UV exposure can be found in Table 3.

TABLE 2
Composition of the clearcoat materials for inventive use (examples 6 to 17)

| | Parts by weight in example: | | | | | | | | | | | |
|---|---|---|---|---|---|---|---|---|---|---|---|---|
| Constituent | 6 | 7 | 8 | 9 | 10 | 11 | 12 | 13 | 14 | 15 | 16 | 17 |
| Solvent mixture^{a)} | 56.4 | 56.4 | 56.4 | 56.4 | 56.4 | 56.4 | 56.4 | 56.4 | 56.4 | 56.4 | 56.4 | 56.4 |
| Uracron ® CY 467^{b)} | 27.7 | 27.7 | 27.7 | 27.7 | 27.7 | 27.7 | 27.7 | 27.7 | 27.7 | 27.7 | 27.7 | 27.7 |
| Cellulose acetobutyrate | 4.5 | 4.5 | 4.5 | 4.5 | 4.5 | 4.5 | 4.5 | 4.5 | 4.5 | 4.5 | 4.5 | 4.5 |
| Flatting agent | 1.8 | 1.8 | 1.8 | 1.8 | 1.8 | 1.8 | 1.8 | 1.8 | 1.8 | 1.8 | 1.8 | 1.8 |
| Mixture (A)^{c)} | 9.1 | | | | | | | | | | | |
| Laromer ® PE55F^{d)} | — | 9.1 | — | — | — | — | — | — | — | — | — | — |
| Laromer ® PO84F^{e)} | — | — | 9.1 | — | — | — | — | — | — | — | — | — |
| Laromer ® 8986^{f)} | — | — | — | 9.1 | — | — | — | — | — | — | — | — |
| Sartomer ® 494^{g)} | — | — | — | — | 9.1 | — | — | — | — | — | — | — |
| Roskydal ® UA V94^{h)} | — | — | — | — | — | 9.1 | — | — | — | — | — | — |
| Parotal ®ⁱ⁾ | — | — | — | — | — | — | 9.1 | — | — | — | — | — |
| Hexanediol diacrylate | — | — | — | — | — | — | — | 9.1 | — | — | | |
| Tripropylene glycol | — | — | — | — | — | — | — | — | 9.1 | — | — | — |
| diacrylate | | | | | | | | | | | | |
| Trimethylolpropane | — | — | — | — | — | — | — | — | — | 9.1 | — | — |
| triacrylate | | | | | | | | | | | | |
| Sartomer ® 9003^{j)} | — | — | — | — | — | — | — | — | — | — | 9.1 | — |
| Laromer ® DVE3^{k)} | — | 9.1 | — | — | — | — | — | — | — | — | — | 9.1 |

^{a)}cf. example 5;
^{b)}saturated (meth)acrylate copolymer from DSM;
^{c)}cf. examples 1 to 4;
^{d)}acrylated polyester, 100%, from BASF Aktiengesellschaft;
^{e)}acrylated polyether, amine-modified, from BASF Aktiengesellschaft;
^{f)}acrylated epoxy resin, 100%, from BASF Aktiengesellschaft;
^{g)}oligoether tetraacrylate from Cray Valley;
^{h)}aliphatic polyurethane acrylate, 80% in hexanediol diacrylate, from Bayer AG;
ⁱ⁾unsaturated polyester based on maleic anhydride, 65% in styrene, from BASF Aktiengesellschaft;
^{j)}neopentyl glycol propylene diacrylate, 100%, from Cray Valley;
^{k)}divinyl ether derivative, 100%, from BASF Aktiengesellschaft;

TABLE 3
König pendulum attenuation testing

| Example and | | |
|---|---|---|
| comparative | | |
| experiment | Double bonds | Pendulum attenuation(s) |

| Exposure | (meq/100 g SC)^{a)} | before exposure | after |
|---|---|---|---|
| 6 | 220 | 34.3 | 112 |
| C3 | 220 | 32.3 | 113.4 |
| 7 | 100 | 28.7 | 53.9 |
| C4 | 100 | 26.6 | 86.1 |
| 8 | 130 | 19.6 | 93.1 |
| C5 | 130 | 19.6 | 93.1 |
| 9 | 160 | 21 | 53.9 |
| C6 | 160 | 21 | 106.4 |
| 10 | 280 | 21 | 110.6 |
| C7 | 280 | 221 | 114.1 |
| 11 | 100 | 30.8 | 107.1 |
| C8 | 100 | 28.7 | 112 |
| 12 | 200 | 33.6 | 41.3 |
| C9 | 200 | 32.2 | 52.5 |
| 13 | 320 | 9.8 | 131.6 |
| C10 | 320 | 9.8 | 136.5 |
| 14 | 240 | 11.2 | 107.1 |
| C11 | 240 | 11.2 | 114.1 |
| 15 | 360 | 16.8 | 116.2 |
| C12 | 360 | 15.4 | 107.8 |
| 16 | 220 | 18.2 | 104.3 |
| C13 | 220 | 16.8 | 105 |
| 17 | 360 | 26.6 | 32.3 |
| C14 | 360 | 26.6 | 39.9 |

^{a)}SC = solids content of (B) + (C)

Examples 6 to 17 and comparative experiments C3 to C14 demonstrate again that the photoinitiator-free clearcoat materials gave in all cases, by means of the process of the invention, clearcoats whose crosslinking was just as good but at least of comparable quality to that of clearcoats produced from the clearcoat materials containing photoinitiator.

1. A process for producing coatings, adhesive films and/or seals from actinic-radiation-curable coating materials, adhesives and/or sealing compounds on and in primed and unprimed substrates by applying the coating materials, adhesives and/or sealing compounds onto and/or into the substrates and curing the resultant films with actinic radiation, using photoinitiator-free coating materials, adhesives and sealing compounds comprising or consisting of, as actinic-radiation-activatable constituents,
A) at least one (meth)acrylate copolymer containing on average per molecule at least one group (a) having at least one bond which can be activated with actinic radiation, the group (a) being attached to the parent structure of the (meth)acrylate copolymer (A) by way of polymer-analogous reactions,
or alternatively
B) at least one compound containing on average per molecule at least one group (a) having at least one bond which can be activated with actinic radiation, and
C) at least one (meth)acrylate copolymer which is free of such groups (a),
and which contain an amount of actinic-radiation-activatable groups of from 70 to 400 meq/100 g of solids.

2. The process of claim 1, characterized in that UV radiation is used as actinic radiation.

3. The process of claim 1 or 2, characterized in that as bonds which can be activated with actinic radiation use is made of carbon-hydrogen single bonds or carbon-carbon, carbon-oxygen, carbon-nitrogen, carbon-phosphorus or carbon-silicon single bonds or double bonds.

4. The process of claim 3, characterized in that carbon-carbon double bonds are used.

5. The process of claim 4, characterized in that (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups or dicyclopentadienyl ester, norbornenyl ester, isoprenyl ester, isopropenyl ester, allyl ester or butenyl ester groups are used as groups (a).

6. The process of claim 5, characterized in that acrylate groups are used.

7. The process of one of claims 1 to 6, characterized in that the parent structure of the compound (B) is of low molecular mass, oligomeric and/or polymeric.

8. The process of claim 7, characterized in that the oligomeric and/or polymeric parent structure of the compound (B) comprises olefinically unsaturated double bonds.

9. The process of claim 7 or 8, characterized in that the oligomeric and/or polymeric parent structure of the compound (B) is derived from random, alternating and/or block, linear, branched, hyperbranched, dendrimeric and/or comb poly-addition resins, polycondensation resins and/or addition (co)polymers of olefinically unsaturated monomers.

10. The process of claim 9, characterized in that the addition (co)polymers (B) are (meth)acrylate copolymers and/or partially saponified polyvinyl esters and the polyaddition resins (B) and/or polycondensation resins (B) are polyesters, alkyds, polyurethanes, polyester-polyurethanes, polylactones, polycarbonates, polyethers, polyether-polyesters, epoxy resin-amine adducts, polyureas, polyamides or polyimides, especially polyesters, polyester-polyethers, polyurethanes, and polyester-polyurethanes.

11. The process of claim 10, characterized in that the (meth)acrylate copolymers (B) are (meth)acrylate copolymers (A).

12. The process of one of claims 1 to 11, characterized in that the groups (a) in the (meth)acrylate copolymers (A) and/or in the compounds (B) are attached to the respective parent structures by way of urethane, urea, allophanate, ester, ether and/or amide groups.

13. The process of claim 17, characterized in that the groups (a) in the compounds (B) are attached to the parent structures by way of urethane groups and in the (meth)acrylate copolymers (A) are attached to the respective parent structures by way of ester groups.

14. The process of one of claims 1 to 13, characterized in that the coatings comprise single-coat and multicoat clearcoat systems and color and/or effect paint systems.

15. The process of one of claims 1 to 8, characterized in that the substrates comprise motor vehicle bodies, parts of motor vehicle bodies, furniture, constructions, windows, doors and industrial components, including containers, coils and electrical components.

16. Photoinitiator-free coating materials, adhesives and sealing compounds containing an amount of actinic-radiation-activatable groups of from 70 to 400 meq/100 g of solids, which comprise or consist of, as actinic-radiation-activatable constituents,
A) at least one (meth)acrylate copolymer containing on average per molecule at least one group (a) having at least one bond which can be activated with actinic radiation, preparable by the group (a) being attached to the parent structure of the (meth)acrylate copolymer (A) by way of polymer-analogous reactions,
or alternatively
B) at least one compound containing on average per molecule at least one group (a) having at least one bond which can be activated with actinic radiation, and
C) at least one (meth)acrylate copolymer which is free of such groups (a).
